(19) United States
(12) Patent Application Publication
(10) Pub. No.: US 2010/0102724 A1
(43) Pub. Date: Apr. 29, 2010

(54) METHOD OF CONSTRUCTING CERAMIC BODY ELECTRODELESS LAMPS

(75) Inventors: Richard Gilliard, Morgan Hill, CA (US); Tom O'Halloran, Sunnyvale, CA (US)

Correspondence Address: SCHWEGMAN, LUNDBERG & WOESSNER, P.A., P.O. BOX 2938, MINNEAPOLIS, MN, 55402, US

(73) Assignee: Luxim Corporation, Sunnyvale, CA (US)

(21) Appl. No.: 12/603,202

(22) Filed: Oct. 21, 2009

Related U.S. Application Data
(60) Provisional application No. 61/107,250, filed on Oct. 21, 2008.

(51) Int. Cl. H01J 61/30; H01J 9/00

(52) U.S. Cl. 313/634; 445/23; 445/43

(57) ABSTRACT

A ceramic body electrodeless lamp and a method to produce the lamp are provided. In an example embodiment, the ceramic body electrodeless lamp may include an open tubular arm body, a filler rod formed to have an outer diameter sized to fit at least partially within an inner diameter of the open tubular arm body, and a frit material to form a seal between the open tubular arm body and the filler rod once the frit material is melted.

### RELATED APPLICATION

This application claims priority to U.S. Provisional Patent Application Ser. No. 61/107,250 entitled, “METHOD OF CONSTRUCTING CERAMIC BODY ELECTRODELESS LAMPS,” filed Oct. 21, 2008; the entire contents of which is incorporated herein by reference.

### BACKGROUND

The field of the present invention relates to a method of construction of ceramic body electrodeless discharge lamps.

### BRIEF DESCRIPTION OF THE DRAWINGS

Novel features of the invention are set forth with particularity in the appended claims. A better understanding of features and advantages of the present invention are obtained by reference to the following detailed description that sets forth illustrative embodiments, in which:

FIG. 1 schematically depicts a ceramic electrodeless lamp with single sealed arm in accordance with an example embodiment.

FIG. 2 schematically depicts three components of the ceramic body arm and seal material in accordance with an example embodiment; namely, an open ceramic tubular body arm itself for dosing as well as a filler rod of the same or similar material and frit glass material to make the seal after the lamp is dosed and filled with rare gas.

FIG. 3 shows detail of the arm end seal in accordance with an example embodiment of the seal after the frit material is melted and the seal created.

FIG. 4 schematically depicts a single seal formed bulb, in accordance with an example embodiment, in a “round” resonant cavity.

FIG. 5 schematically depicts a double seal cylindrical bulb, in accordance with an example embodiment, in a “square” resonant cavity.

### DETAILED DESCRIPTION OF DRAWINGS

While the inventive subject matter described herein is open to various modifications and alternative constructions, the embodiments shown in the drawings will be described by way of example herein in detail. It is to be understood, however, there is no intention to limit the inventive subject matter to the particular forms disclosed. On the contrary, it is intended that the inventive subject matter cover all modifications, equivalences and alternative constructions falling within the spirit and scope of the inventive subject matter.

### Overview

Use of a ceramic lamp body, as opposed to a fused silica or quartz body, may present many fundamental advantages in an electrodeless lamp. In particular, the ceramic lamp body may enable higher temperature operation of the lamp body that, in turn, enables higher efficacy, better color control, and slower chemical wall reaction and therefore longer lamp life. Color consistency, lamp to lamp, and color constancy, as the lamps are aged, are also improved. In example embodiments set out below, a method of construction is described of such a lamp that enhances reliable and economical manufacture of such an arc tube. Creation of a hermetic final seal in an ultraclean environment after the lamp is dosed with volatile chemical fill materials is a challenge, particularly when high sealing temperatures (1000° C. or greater) are required to ensure that the seal will remain intact during the severe conditions of temperature and pressure during normal operation of the lamp.

### Example Embodiments

Various features of the inventive subject matter relate to the construction technology described herein. The precise geometry of the bulb itself, fill materials, or gases inserted into the bulb are essentially independent of the seal technology.

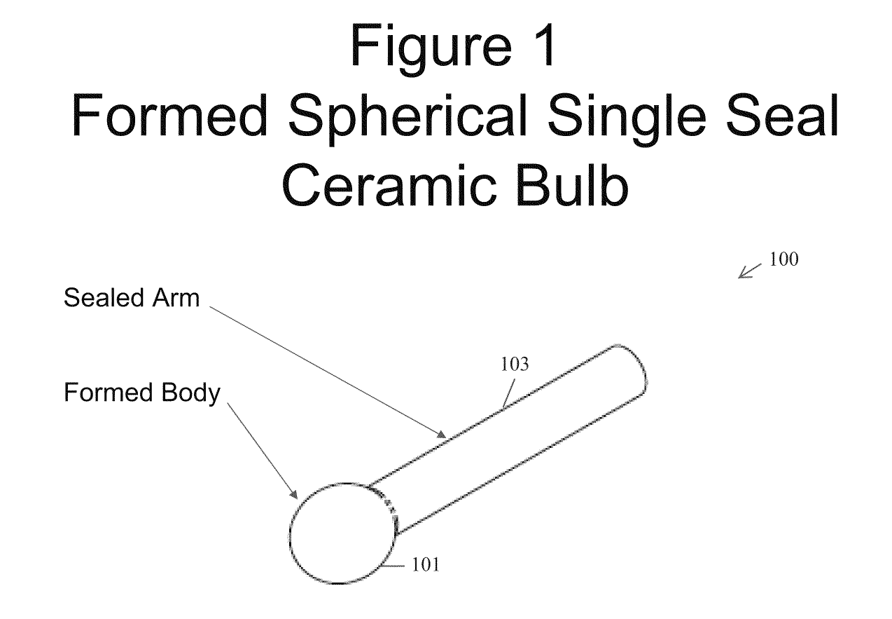

Referring to FIG. 1, an example formed spherical single seal ceramic bulb 100 is shown. Lamps may have a body 101 of arbitrary shape, although in an example embodiment, the lamp will be convex. The body 101 may be fabricated from poly-crystalline-alumina (PCA), although other ceramic materials might be used instead, and may have at least one sealed cylindrical arm 103 through which dosing materials and fill gas can be introduced.

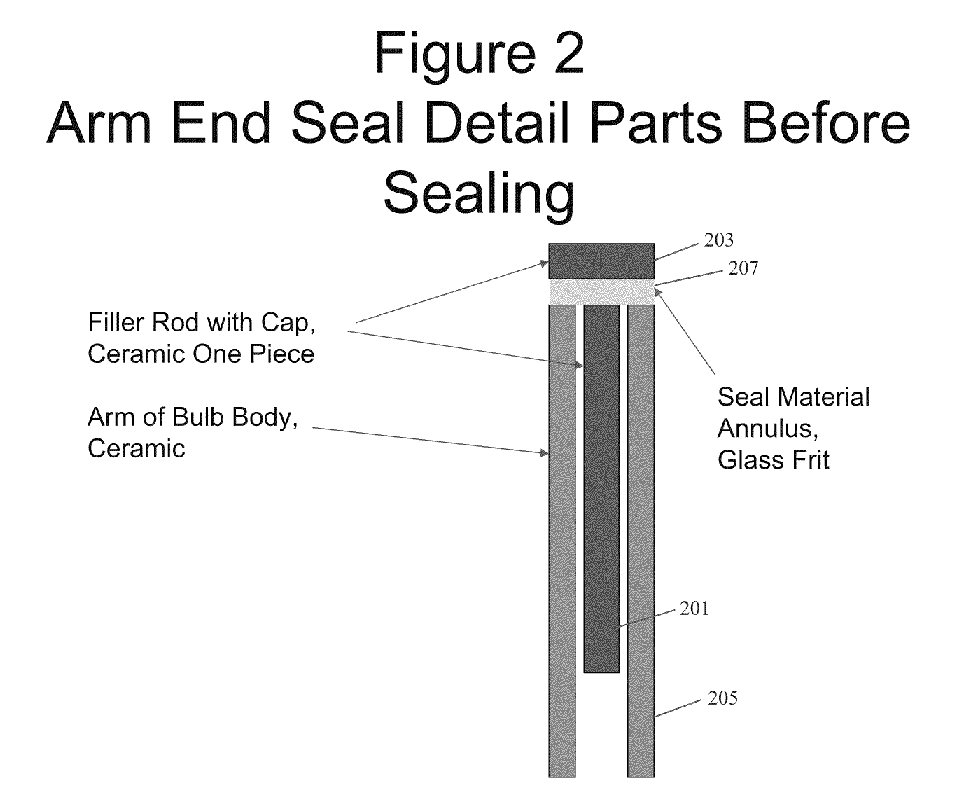

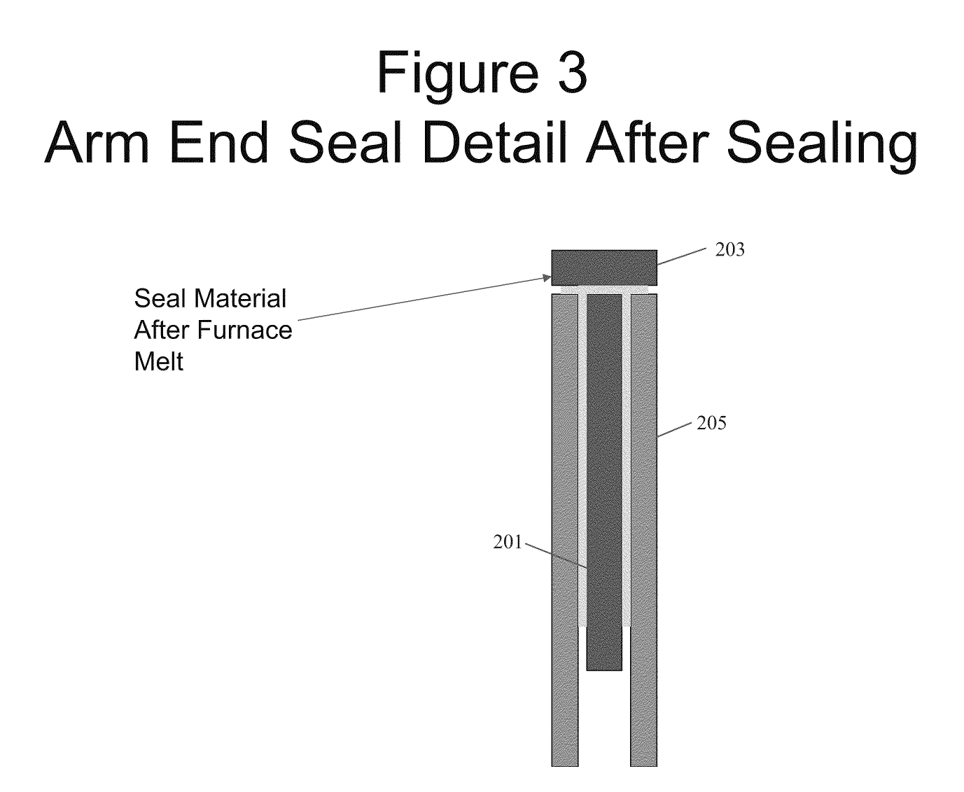

Referring to FIG. 2, mating to the sealing arm (e.g., the sealed cylindrical arm 103 of FIG. 1) is a ceramic rod 201 of the same or similar material; the outer diameter of the ceramic rod 201 will be slightly smaller than the inner diameter of a corresponding arm body 205 (e.g., approximately a 0.1 mm difference). Various means can be employed to hold the ceramic rod 201 in place during the sealing process such as a larger diameter cap 203 shown in FIGS. 2 and 3 or an outer looped refractory wire (not shown) through a notch in the ceramic rod 201. Completing the seal will be a seal glass material 207 (also in FIG. 3), that, when melted, forms a hermetic seal between the ceramic rod 201 and the arm body 205 and be able to withstand the high temperatures, pressures, and chemical reactivities inherent in an operating lamp.

FIG. 3 shows the detail of the three pieces described with reference to FIG. 2 after heating. The heating creates the hermetic seal. In an example embodiment, the sealing process is performed as described, below.

The lamp body is introduced into a controlled atmosphere chamber in which the dosing materials can be introduced to the body. This is carried out in a high purity rare gas glove box. The dosing materials may be any type of materials to include metals, metal halides, or other chemicals.

After the dosed materials are placed in the body, the seal glass material 207, such as glass frit, and the ceramic rod 201 are put in place as indicated in FIG. 2. The ceramic rod 201 may have the cap 203 on it, as shown, to hold it in place or the ceramic rod 201 may have other means of being secured such as a notch (not shown) by which the ceramic rod 201 may be secured using a refractory metal wire (not shown). The wire is configured such that, when the frit material is melted, the wire remains outside the sealed body.

The dosed body, with rod and frit material in place, is then placed into a high purity furnace that is filled with the rare-gas fill material to a desired pressure. The end of the rod/frit/bulb assembly is then raised to a temperature sufficient to soften the frit material to create a hermetic seal, but not above the softening temperature of the ceramic rod 201 and the arm body 205. The arm body 205 is independently cooled during this process so as to ensure that the dose materials do not evaporate from the body.

The assembly is then cooled and removed from the furnace. The process above describes the final seal. If the body has more than one arm, the first seal may be accomplished in a similar manner, but, in an example embodiment, cooling of the body is not necessary. The gas atmosphere in the furnace for all but the final seal may be any non-reactive gas at the seal temperatures (e.g., a rare gas).

In an example embodiment, a key feature of the process design is that the amount of material used for the glass frit is such that, when melted, the material will extend roughly half of the length of the arm down the tube. The essence of this feature is that the dosed materials (e.g., rare earth metal halide) condensate will extend down the arm and remain at a low enough temperature (e.g., 700° C.) so as to ensure very limited chemical reaction between the condensate and the glass material. At the same time, the condensate will extend into the body to a sufficient distance to ensure that the surface of the pool is at high enough temperature to result in a high vapor pressure of the material.

In an example embodiment, the body materials as indicated are typically poly-crystalline alumina (PCA). The rod material may be the same so as to prevent any thermal mismatch and ensure the strongest possible seal. In an example embodiment, the glass frit material has the following selected properties. For example, the glass frit material will soften, and then wet and fill the inside of the tube, so as to deform and create a hermetic seal with the rod and arm materials when exposed to a temperature of order 1000° C. The glass frit material may also be selected to be thermally compatible with the arm and rod materials (e.g., in terms of expansion at lamp operating temperatures, chemical compatibility, etc.) Furthermore, the glass frit material may be selected to not be chemically reactive with the dose materials at a temperature comparable to an operating temperature of the innermost extension of the frit material when the lamp is under normal operation.

In an example embodiment, an electrodeless discharge light source is provided which emits useful radiation (visible, ultraviolet, or infrared) when excited by an external electric field which may be inductively coupled, capacitively coupled, or supplied by a resonant cavity or any other means.

In an example embodiment, the final structure (bulb) encloses materials in specified amounts of the order of 10⁻⁵ grams to an accuracy of 10⁻⁶ grams in a hermetically sealed vessel. The dosed material (e.g., metal halides) is not exposed to air or the dosed material may instantly draw moisture to an unacceptable level of impurity (e.g., approximately 10 ppm H₂O) in the 10⁻⁵ gram dose, which may contaminate the lamp to a level that it will not ignite and will otherwise have short usable life due to accelerated chemical reaction between the (rare earth) dose and the wall material. The bulb and seal can withstand 50 to 100 atmospheres of pressure, or more, at wall temperatures of greater than 1000° C. during normal operation.

The seal is created at a temperature of approximately 1000° C. in an ambient that will neither volatilize nor contaminate the internal bulb materials. For example, the length of the arm is maintained at 1000° C. on one end and at 30° C. on the other end (inside the bulb) simultaneously so as to heat the arm to high enough temperature to create a seal at the one end, and approximately 10 mm away along the length of the material at a low enough temperature to keep the dose materials from evaporating out the arm in the controlled atmosphere before the closure is made and while the arm is heating up. This process may be performed in a 99.999% purity argon or other rare gas environment.

The sealing (heating) process described leaves the bulb and arm materials in a consistent geometric shape after the high temperature exposure. Generally, the process described results in either no deformation or at least a consistent deformation part-to-part. The process is reproducible, high speed, and economical (e.g., a few dollars per part at one per minute cycle time) in order to maintain relative value to the level of improvement over a less-expensive-to-produce quartz body bulb.

In an example embodiment, the vapor pressure of a material is determined by coldest temperature spot on the wall. The vapor pressure issue during the actual sealing (heating) process may be determined by the temperature extremes (e.g., about 30° C. on one end and about 1000° C. on the other) at either end of the arm during the sealing process. The seal may be about 800° C. to about 1000° C., but the limits could be expanded.

The discharge lamp may comprise a ceramic body of a transparent or translucent material of high transmission. Hermetically sealed materials within the discharge lamp emit useful radiation when excited by an external field. At least one cylindrical arm with a cylindrical hole can be utilized to introduce dosing materials and gas or gases for the discharge lamp and a rod of similar material can be used to fill in the arm after dosing and filling. A glass frit material is selected that softens at temperatures on the order of 800° C. to 1000° C. to form a hermetic seal between the arm and rod and can withstand temperatures and internal pressures of an operating lamp. A sealing process capable of heating the frit and outer end of the arm to a temperature sufficient to soften the frit glass and form the seal in an atmosphere of the final fill gas. The sealing process can cool the lamp body during the sealing process so as to prevent evaporation of volatile materials inside the bulb during the heating of the bulb seal.

The arm is designed to ensure that excess volatile dosed materials are contained in the lamp so that when the lamp is operating the excess material fills a region in the arm between the end of the frit seal and the inner bulb body.

A temperature at the junction where the condensate and frit material meet in the arm during operation is low enough so as to ensure low chemical reactivity between the glass and dose materials and such that the outer surface of the condensate inside the body is at sufficient temperature to ensure adequate vapor pressure of the dosed materials within the bulb.

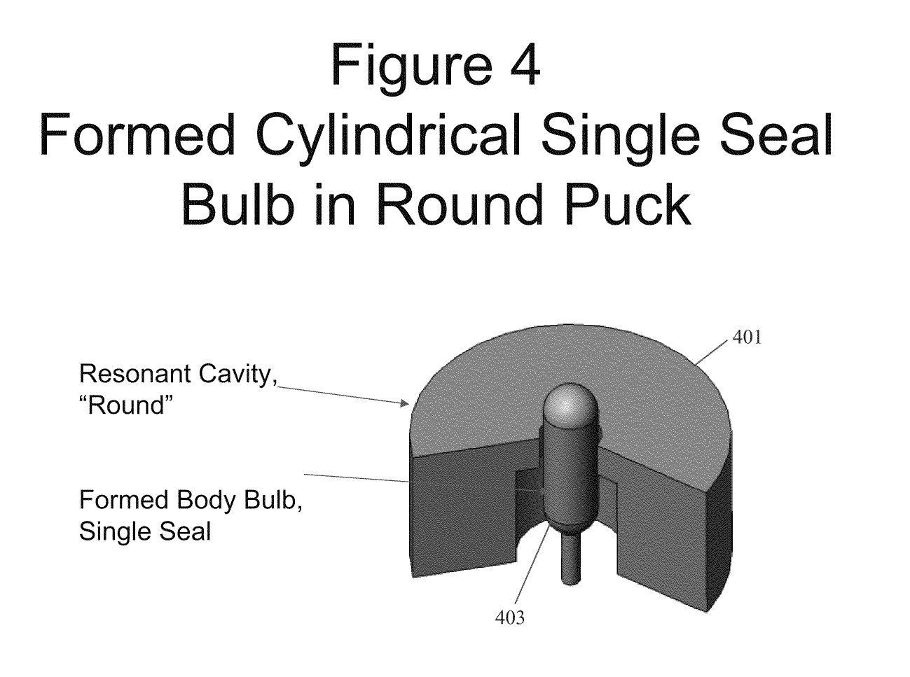

Example Embodiment of the Round Resonant Cavity of FIG. 4

In the example of FIG. 4, the plasma lamp may have a lamp body 401 formed from one or more solid dielectric materials and a bulb 403 positioned proximate or adjacent to the lamp body 401. In this example embodiment, the bulb 403 is a cylindrical single seal type. The bulb 403 contains a fill that is capable of forming a light emitting plasma. A lamp drive circuit (not shown) couples radio frequency power into the lamp body 401 that, in turn, is coupled into the fill in the bulb 403 to form the light emitting plasma. In example embodiments, the lamp body 401 forms a waveguide that contains and guides the radio frequency power. In example embodiments, the radio frequency power may be provided at or near a frequency that resonates within the lamp body 401. This is an example only and some embodiments may use a different electrodeless plasma lamp, such as a capacitively or inductively coupled plasma lamp, or other high intensity discharge lamp.

The example plasma lamp has a drive probe (not shown) inserted into the lamp body 401 to provide radio frequency power to the lamp body 401. A lamp drive circuit (not shown) including a power supply, such as amplifier, may be coupled to the drive probe to provide the radio frequency power. The amplifier may be coupled to the drive probe through a matching network to provide impedance matching. In an example embodiment, the lamp drive circuit is matched to the load (formed by the lamp body, bulb, and plasma) for the steady state operating conditions of the lamp. The lamp drive circuit is matched to the load at the drive probe using a matching network (not shown).

In example embodiments, radio frequency power may be provided at a frequency in the range of between about 50 MHz and about 10 GHz or any range subsumed therein. The radio frequency power may be provided to drive probe at or near a resonant frequency for the lamp body 401. The frequency may be selected based on the dimensions, shape and relative permittivity of the lamp body 401 to provide resonance in the lamp body 401. In example embodiments, the frequency is selected for a fundamental resonant mode of the lamp body 401, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the electrodeless plasma lamp according to example embodiments may be used in entertainment lighting or architectural lighting or other lighting applications. In particular examples, the lamp is used in moving head entertainment fixtures, fixed spot fixtures, architectural lighting fixtures or event lighting fixtures. Example embodiments may also be used in street and area lighting and other lighting applications. The entire disclosure of U.S. patent application Ser. No. 12/562,630, entitled, “ELECTRODELESS PLASMA LAMP AND DRIVE CIRCUIT,” filed Sep. 18, 2009 is incorporated herein by reference.

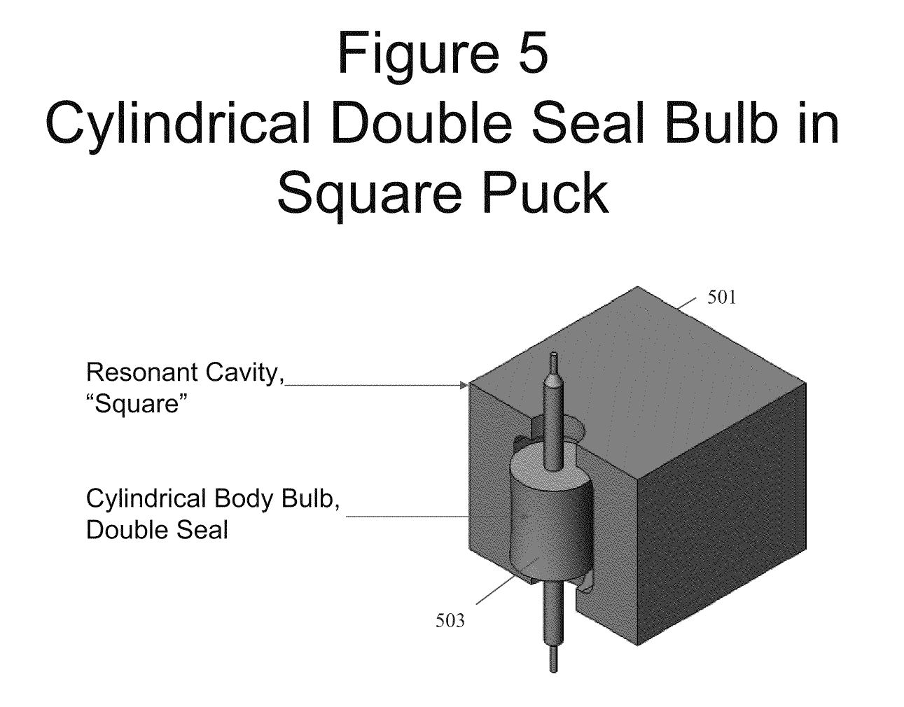

Example Embodiment of the Square Resonant Cavity of FIG. 5

In the example of FIG. 5, the plasma lamp may have a lamp body 501 formed from one or more solid dielectric materials and a bulb 503 positioned adjacent to the lamp body 501. In this example embodiment, the bulb 503 is a cylindrical double seal type. The bulb 503 contains a fill that is capable of forming a light emitting plasma. A lamp drive circuit (not shown) couples radio frequency power into the lamp body 501 that, in turn, is coupled into the fill in the bulb 503 to form the light emitting plasma. In example embodiments, the lamp body 501 forms a waveguide that contains and guides the radio frequency power. In example embodiments, the radio frequency power may be provided at or near a frequency that resonates within the lamp body 501. This is an example only and some embodiments may use a different electrodeless plasma lamp, such as a capacitively or inductively coupled plasma lamp, or other high intensity discharge lamp.

In one example embodiment (not shown in FIG. 5 but described in detail in application PCT/US2007/082022, entitled “ELECTRODELESS LAMPS AND METHODS,” filed Oct. 19, 2007 and incorporated herein by reference in its entirety), an electrodeless plasma lamp comprises a source of radio frequency (RF) power, a bulb containing a fill that forms a plasma when the RF power is coupled to the fill, and a dipole antenna proximate the bulb. The dipole antenna may comprise a first dipole arm and a second dipole arm spaced apart from the first dipole arm. The source of RF power may be configured to couple the RF power to the dipole antenna such that an electric field is formed between the first dipole arm and the second dipole arm. The dipole antenna may be configured such that a portion of the electric field extends into the bulb and the RF power is coupled from the dipole antenna to the plasma.

In one example embodiment, a method of generating light is described. The method may comprise providing a bulb containing a fill that forms a plasma when the RF power is coupled to the fill, and providing a dipole antenna proximate the bulb, the dipole antenna comprising a first dipole arm and a second dipole arm spaced apart from the first dipole arm. The RF power may be coupled to the dipole antenna such that an electric field is formed between the first dipole arm and the second dipole arm, and RF power is coupled from the dipole antenna to the plasma. “Hotspots” may arise in circumstances where an arc is not substantially centered and using the ceramic bulb, as herein before described, may provide an advantage over a quartz bulb.

Some example embodiments provide systems and methods for increasing the amount of collectable light into a given etendue from an electrodeless plasma lamp, such as a plasma lamp using a solid dielectric lamp body. A maximum (or substantially maximum) electric field may be deliberately transferred off center to a side (or proximate a side) of a dielectric structure that serves as the body of the lamp. A bulb of the electrodeless lamp may be maintained at the side (or proximate the side) of the body, coinciding with the offset electric field maximum. In an example embodiment, a portion of the bulb is inside the body, and the rest of the bulb protrudes out the side in such a way that an entire (or substantially entire) plasma arc is visible to an outside half-space.

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

In some example embodiments, the electric field is substantially parallel to the length of a bulb or the length of a plasma arc formed in the bulb. In some example embodiments, 40% to 100% (or any range subsumed therein) of the bulb length or arc length is visible from outside the lamp and is in line of sight of collection optics.

In some examples, the orientation of the bulb allows a thicker bulb wall to be used while allowing light to be efficiently transmitted out of the bulb. In one example, the thickness of the side wall of the lamp is in the range of about 2 mm to 10 mm or any range subsumed therein. In some examples, the thicker walls allow a higher power to be used without damaging the bulb walls and use of the ceramic bulb may be advantageous. In one example, a power of greater than 150 watts may be used to drive the lamp body. In one example, a fill of a noble gas, metal halide, and mercury is used at a power of 150 watts or more with a bulb wall thickness of about 3 to 5 mm.

In some examples, a reflector or reflective surface is provided on one side of an elongated bulb. In some examples, the reflector may be a specular reflector. In some embodiments, the reflector may be provided by a thin film, multi-layer dielectric coating. In some examples, the other side of the bulb is exposed to the outside of the lamp. In some embodiments, substantial light is transmitted through the exposed side without internal reflection and substantial light is reflected from the other side and out of the exposed side with only one internal reflection. In example embodiments, light with a minimal number (e.g., one or no internal reflections) comprises the majority of the light output from the bulb. In some embodiments, the total light output from the bulb is in the range of about 5,000 to 20,000 lumens or any range subsumed therein.

In some examples, power is provided to the lamp at or near a resonant frequency for the lamp. In some examples, the resonant frequency is determined primarily by the resonant structure formed by electrically conductive surfaces in the lamp body rather than being determined primarily by the shape, dimensions, and relative permittivity of the dielectric lamp body. In some examples, the resonant frequency is determined primarily by the structure formed by electrically conductive field concentrating and shaping elements in the lamp body. In some examples, the field concentrating and shaping elements substantially change the resonant waveform in the lamp body from the waveform that would resonate in the body in the absence of the field concentrating and shaping elements. In some embodiments, an electric field maxima would be positioned along a central axis of the lamp body in the absence of the electrically conductive elements. In some examples, the electrically conductive elements move the electric field maxima from a central region of the lamp body to a position adjacent to a surface (e.g., a front or upper surface) of the lamp body. In some examples, the position of the electric field maxima is moved by 20 to 50% of the diameter or width of the lamp body or any range subsumed therein. In some examples, the position of the electric field maxima is moved by 3 to 50 mm (or any range subsumed therein) or more relative to the position of the electric field maxima in the absence of the conductive elements. In some examples, an orientation of the primary electric field at the bulb is substantially different than an orientation in the absence of the electrically conductive elements. In one example, a fundamental resonant frequency in a dielectric body without the electrically conductive elements would be oriented substantially orthogonal to the length of the bulb. In the example embodiments described herein, a fundamental resonant frequency for the resonant structure formed by the electrically conductive elements in the lamp body results in an electric field at the bulb that is substantially parallel to the length of the bulb.

In some examples, the length of the bulb is substantially parallel to a front surface of the lamp body. In some embodiments, the bulb may be positioned within a cavity formed in the lamp body or may protrude outside of the lamp body. In some examples, the bulb is positioned in a recess formed in the front surface of the lamp body. In some examples, a portion of the bulb is below the plane defined by the front surface of the lamp body and a portion protrudes outside the lamp body. In some examples, the portion below the front surface is a cross section along the length of the bulb. In some examples, the portion of the front surface adjacent to the bulb defines a cross section through the bulb along the length of the bulb. In some examples, the cross-section substantially bisects the bulb along its length. In other examples 30% to 70% (or any range subsumed therein) of the interior of the bulb may be below this cross-section and 30% to 70% (or any range subsumed therein) of the interior of the bulb may be above this cross section.

In example embodiments, the volume of lamp body may be less than those achieved with the same dielectric lamp bodies without conductive elements in the lamp body, where the resonant frequency is determined primarily by the shape, dimensions, and relative permittivity of the dielectric body. In some examples, a resonant frequency for a lamp with the electrically conductive resonant structure according to an example embodiment is lower than a fundamental resonant frequency for a dielectric lamp body of the same shape, dimensions and relative permittivity. In example embodiments, it is believed that a lamp body using electrically conductive elements according to example embodiments with a dielectric material having a relative permittivity of 10 or less may have a volume less than about 3 cm³ for operating frequencies less than about 2.3 GHz, less than about 4 cm³ for operating frequencies less than about 2 GHz, less than about 8 cm³ for operating frequencies less than about 1.5 GHz, less than about 11 cm³ for operating frequencies less than about 1 GHz, less than about 20 cm³ for operating frequencies less than about 900 MHz, less than about 30 cm³ for operating frequencies less than about 750 MHz, less than about 50 cm³ for operating frequencies less than about 650 MHz, and less than about 100 cm³ for operating frequencies less than about 650 MHz. In one example embodiment, a volume of about 13.824 cm³ was used at an operating frequency of about 880 MHz. It is believed that similar sizes may be used even at lower frequencies below 500 MHz.

In some examples, a volume of the bulb may be less than a volume of the lamp body. In some examples, the volume of the lamp body may be 3 to 100 times (or any range subsumed therein) of the volume of the bulb.

In example embodiments, the field concentrating and shaping elements are spaced apart from the RF feed(s) that provide RF power to the lamp body. In example embodiments, the RF feed is a linear drive probe and is substantially parallel to the direction of the electric field at the bulb. In some examples, the shortest distance from the end of the RF feed to an end of the bulb traverses at least one metal surface in the body that is part of the field concentrating and shaping elements. In some examples, a second RF feed is used to obtain feedback from the lamp body. In some examples, the shortest distance from the end of the drive probe to an end of the feedback probe does not traverse an electrically conductive material in the lamp body. In some examples, the shortest distance from the end of the feedback probe to an end of the bulb traverses at least one metal surface in the body that is part of the field concentrating and shaping elements. In some examples, the RF feed for providing power to the lamp body is coupled to the lamp body through a first side surface and the RF feed for obtaining feedback from the lamp body is coupled to the lamp body through an opposing side surface. In example embodiments, the bulb is positioned adjacent to a different surface of the lamp body than the drive probe and feedback probe.

In some example embodiments, the field concentrating and shaping elements are formed by at least two conductive internal surfaces spaced apart from one another in the lamp body. In some examples, these electrically conductive surfaces form a dipole. In example embodiments, the closest distance between the first internal surface and the second internal surface is in the range of about 1 to 15 mm or any range subsumed therein. In one example, portions of these internal surfaces are spaced apart by about 3 mm. In one example, the internal surfaces are spaced apart from an outer front surface of the lamp body. The front surface of the lamp body may be coated with an electrically conductive material. In some example embodiments, the inner surfaces are spaced from the outer front surface by a distance of less than about 1 to 10 mm or any range subsumed therein. In one example, the inner surfaces are spaced from the outer front surface by a distance less than an outer diameter or width of the bulb. In some examples this distance is less than 2 to 5 mm or any range subsumed therein.

In some examples, the ceramic bulb is positioned adjacent to an uncoated surface (e.g., a portion without a conductive coating) of the lamp body. In example embodiments, power is coupled from the lamp body to the bulb through an uncoated dielectric surface adjacent to the bulb. In example embodiments, the surface area through which power is coupled to the bulb is relatively small. In some embodiments, the surface area is in the range of about 5% to 100% of the outer surface area of the bulb or any range subsumed therein. In some examples, the surface area is less than 60% of the outer surface area of the bulb. In some example embodiments, the surface area is less than 200 mm². In other examples, the surface area is less than 100 mm², 75 mm², 50 mm², or 35 mm². In some embodiments, the surface area is disposed asymmetrically adjacent to one side of the bulb. In some embodiments, power is concentrated in the middle of the bulb and a small plasma arc length is formed that does not impinge on the ends of the bulb. In some examples, the plasma arc length is less than about 20% to 95% of the interior length of the bulb or any range subsumed therein. In some examples, the plasma arc length is within the range of 2 mm to 5 mm or any range subsumed therein.

The description provided herein includes illustrative systems, methods, techniques, and instruction sequences that embody at least portions of the inventive subject matter. In the foregoing description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, circuits, and techniques have not been shown in detail. Moreover, as used herein, the term “or” may be construed in either an inclusive or an exclusive sense. It is therefore understood that each of the above aspects of example embodiments may be used alone or in combination with other aspects described herein.

What is claimed is:

1. A method to produce a ceramic body electrodeless lamp, the method comprising:
selecting an open tubular arm body;
placing a ceramic fill rod within the open tubular arm body;
placing a frit material proximate to an open end of the open tubular arm body; and
placing the open tubular arm body, the ceramic fill rod, and the frit material in a furnace at a temperature sufficient to melt the frit material without substantially deforming the open tubular arm body and the ceramic fill rod, the frit material, once melted, forming a seal between the open tubular arm body and the ceramic fill rod.

2. The method of claim 1, further comprising dosing the electrodeless lamp with a chemical fill material prior to melting the frit material, the chemical fill material to include at least one material including metals and metal halides.

3. The method of claim 1, further comprising forming a cap on one end of the ceramic fill rod to secure the ceramic fill rod in position within the open tubular arm body.

4. A ceramic body electrodeless lamp comprising:
an open tubular arm body to receive a dosing material;
a filler rod formed to have an outer diameter sized to fit at least partially within an inner diameter of the open tubular arm body; and
a frit material to form a seal between the open tubular arm body and the filler rod.

5. The ceramic body electrodeless lamp of claim 4, wherein the open tubular arm body is formed from a first ceramic material and the filler rod is formed from a second ceramic material, the second ceramic material having similar thermal characteristics to the first ceramic material.

6. The ceramic body electrodeless lamp of claim 4, further comprising a bulb containing a fill to form a plasma when radio frequency power is coupled to the fill.
